(19) United States
(12) Patent Application Publication
(10) Pub. No.: US 2008/0314052 A1
(43) Pub. Date: Dec. 25, 2008

(54) Freezing and Storage Container For Biopharmaceutical Drug Products

(76) Inventor: Youn-Ok Shin, Glenside, PA (US)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 12/095,761

(22) PCT Filed: Dec. 1, 2006
(86) PCT No.: PCT/US06/61452

§ 371 Date: Jun. 2, 2008

(51) Int. Cl. F25C 1/00; B32B 1/02

(52) U.S. Cl. 62/66; 428/34.1

(57) ABSTRACT

A container for storing a biopharmaceutical drug product is disclosed. The container includes two surface area planar walls. A plurality of smaller side walls circumscribing each of the planar walls. A method of freezing at least one biopharmaceutical product in the container is also disclosed.

### FIELD OF THE INVENTION

The present invention relates to a container that is used to contain biopharmaceutical material that is intended to be frozen for storage and shipping.

### BACKGROUND OF THE INVENTION

Biopharmaceutical drugs are manufactured in bulk amounts in order to lower the cost per unit of the drug. Oftentimes, the drugs are manufactured in a liquid form, with drug-containing solutes being homogeneously dissolved in a liquid solution. In order to enhance the lifetime of the drug, the drug is frozen in a container that is suitable for transport.

It is well known that solutes in bulk liquid solutions are subject to a stress force induced by the advancement of the ice front during the freezing process. Depending on the ice front velocity, solutes can be either trapped in the solid phase or pushed away from the ice-liquid interface into the bulk liquid region. The migration of the solute into the liquid phase results in a heterogeneous solute distribution in the frozen material. Testing of such migration has indicated that the difference of solute percentage in the solution can be between 60% and 300% of the initial (pre-freezing) value. One solution to limit this migration is to reduce the time required to freeze the solution.

The heat transfer process during freezing is well characterized by the Stefan solution equation, which correlates the thickness of the ice formed after a period of time when the temperature of the cold surface as well as the ice conductivity and heat of fusion are known. The equation indicates that the time required to freeze liquid in a container is a function of the square of the distance that heat travels from the liquid. Therefore, a reduction in the time required to freeze the liquid requires a reduction in the distance that the heat must travel to be removed from the liquid.

It would be beneficial to develop a container in which a liquid drug may be stored and frozen, such that the container has a geometry that reduces the migration of solute during the freezing process.

### SUMMARY OF THE INVENTION

Briefly, the present invention provides a container for storing a biopharmaceutical drug product. The container includes two side surface walls, typically planar, and a plurality of smaller side walls, which circumscribe and connect the surface area planar walls and define the interior of the container.

In one embodiment, the invention relates to a container for storing a biopharmaceutical drug product comprising two relatively large surface area planar surfaces extending opposite to one another. For example, a first and second planar surface can be intersecting, non-parallel, or parallel to each other. In addition, one embodiment also includes a plurality of relatively small surface area side walls circumscribing each of the first and second planar surfaces, wherein the plurality of side walls connect the first and second relatively large surface area surfaces, all of said surfaces collectively defining the interior of the container.

In another embodiment, the first and second relatively large surface area planar surfaces are parallel surfaces.

In yet another embodiment of the invention, one of the plurality of side walls extends at an oblique angle relative to an adjacent of the plurality of side walls. In another embodiment, the remaining side walls each define at least a portion of a side of a rectangle.

In another embodiment, the container further comprises an opening formed within one of the plurality of side walls. In another embodiment, container further comprises a nipple formed around the opening and extending outwardly from the one of the plurality of side walls. In yet another embodiment, the container has a nipple that extends within the rectangle.

In another embodiment of the invention, the container's second planar surface is spaced from the first planar surface by a distance of between about 5 to 11 centimeters. In another embodiment, the second planar surface is spaced from the first planar surface by a distance of about 8 centimeters.

In a further embodiment, the container's first planar surface is spaced from the second planar surface by a distance, and wherein a maximum dimension of each of the first and second planar surface is no more than ten times that of the distance.

In another embodiment of the invention, the container's first and second planar surface and the plurality of side walls all have a thickness of between about 0.1 to 0.95 centimeters.

Additionally, the present invention includes a method of freezing a biopharmaceutical product. The method comprises the step of providing a container, as described above. The method further includes the steps of inserting the biopharmaceutical product into the container; subjecting the container to freezing conditions; and freezing the biopharmaceutical product within the container while maintaining a generally homogenous solution.

In another embodiment of the invention, the specification discloses a method of freezing a biopharmaceutical product comprising the steps of providing a container having two relatively large surface area planar walls extending opposite to one another and a plurality of relatively small surface area side walls circumscribing each of the first and second planar surfaces, wherein the plurality of side walls connect the first and second planar surfaces, all of said surfaces collectively defining the interior of the container. The method also includes, inserting the biopharmaceutical product into the container, subjecting the container to freezing conditions, and freezing the biopharmaceutical product within the container while maintaining a generally homogenous solution.

### BRIEF DESCRIPTION OF THE DRAWINGS

The foregoing summary, as well as the following detailed description of desired embodiments of the invention, will be better understood when read in conjunction with the appended drawings, which are incorporated herein and constitute part of this specification. For the purposes of illustrating the invention, there are shown in the drawings an embodiment that is presently desired. It should be understood, however, that the invention is not limited to the precise arrangements and instrumentalities shown. In the drawings, the same reference numerals are employed for designating the same elements throughout the several figures. In the drawings:

FIG. 1 is a perspective view of a container according to one embodiment of the present invention;

FIG. 2 is a sectional view of the container of FIG. 1; and

FIG. 3 is a sectional view of the container taken along lines 3-3 of FIG. 2.

### DETAILED DESCRIPTION OF THE INVENTION

Certain terminology is used herein for convenience only and is not to be taken as a limitation on the present invention. The terminology includes the words specifically mentioned, derivatives thereof and words of similar import. The following describes a desired embodiment of the invention. However, it should be understood based on this disclosure, that the invention is not limited by the desired embodiment of the invention.

Referring generally to the figures, a container 100 for receiving, freezing, and storing a biopharmaceutical product 102 is shown.

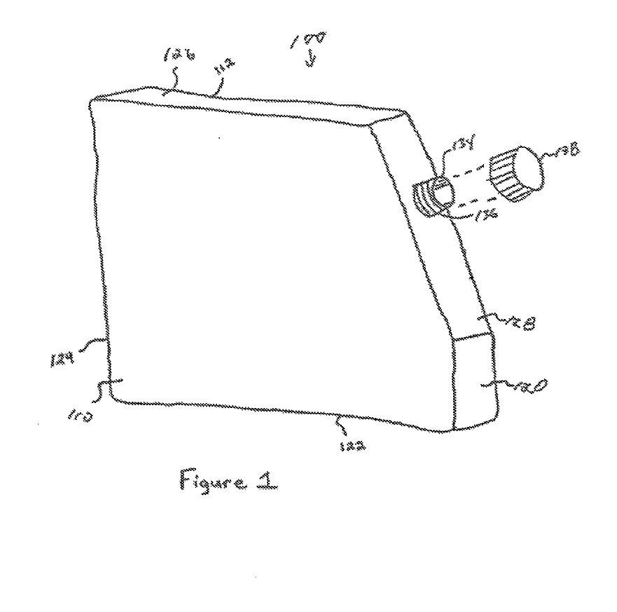

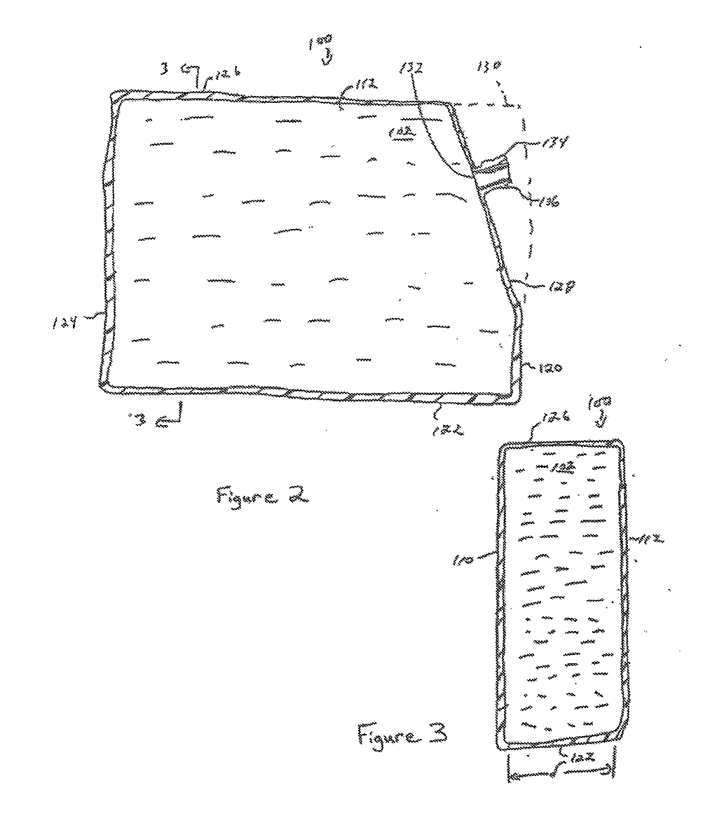

Referring specifically to FIGS. 1 and 2, the container 100 includes a first generally planar wall 110 and a second generally planar wall 112. In one embodiment, the first and second planar walls 110 and 112 are generally parallel to each other and are spaced apart from each other by a distance. The “distance” that separates the first and second planar walls 110 and 112 is determined by the width of the smaller side walls. In another embodiment of the invention, the dimensions of the container mentioned herein are the outside dimension/measurements of the container. For example, the distance between the first and second planar walls 110 and 112 can be 8 cm if the width of the smaller side walls 120, 122, 124, 126, and 128 are all 8 cm wide. In another embodiment, the first and second side planar walls 110 and 112 may be spaced apart from each other by about 5 to about 11 centimeters in order to provide a sufficient rate of freezing of the biopharmaceutical product 102 in the container 100, while still providing acceptable height and length dimension of the container 100 to retain a desired fluid volume.

The time, t, required to fully freeze a solution in such a container is determined by the Stephan Equations (below), which calculate freezing time in a container as a function of distance. The Stephan equations are as follows:

$$t = \frac{{ρ}_{s} {λ}^{′}}{2 {k}_{s} ( {T}_{f} - {T}_{W} )} {δ}^{2} \qquad Equation 1$$

λ′=λ+Cp_{L}(Tᵢ−T_{f}) Equation 2

where:

δ=heat transfer length (m)

λ=latent heat of fusion (J/kg)

ρₛ=density of ice (kg/m³)

Cp_{L}=heat capacity of the solution (J/kg.° K.)

kₛ=heat conductivity of ice (W/m. ° K.)

Tᵢ=initial temperature of the solution (° K.)

T_{f}=freezing temperature of the solution (° K.)

T_{w}=freezer wall temperature (° K.)

t=time (s)

Different solutions, which represent solutions that may be stored in the container 100, were analyzed to determine freeze rates for different container sizes. The solutions tested were distilled water, 0.5 M NaCl solution, and formulation buffers comprising 12% and 18% sucrose. The freezing times were about the same for these solutions, with the note that the freezing temperature of the 0.5 M NaCl and the formulation buffers was −1.5+0.5 degrees Celsius, as opposed to 0 degrees Celsius for the water.

Using equations 1 and 2, and the aforementioned baseline solutions, with the distance between the planar walls 110 and 112 of the container 100 being 5 cm, which corresponds to a heat transfer length of 2.5 cm since the beat is removed from both sides of the container 100, freezing time was calculated to be about 12.6 minutes. Thus, the average ice front velocity is about 119 mm/hr. Similarly, the average ice front velocity of the container 100 with a distance 8 of 11 cm, which corresponds to a heat transfer length of 5.5 cm, is about 54 mm/hr. Freezing time was calculated to be about 61.1 minutes.

In one embodiment, in order to minimize solute re-distribution in the container 100 during freezing, the freezing velocity is to be at least 50 mm/hr or faster, corresponding to a maximum surface area planar wall spacing of about 11 cm. Further, in another embodiment, a minimum planar wall spacing of the container 100 is about 5 cm. Otherwise, the container 100 to be used for large bulk material, for example about 5 to about 50 liters would necessarily have to be very thin and very tall in order to contain a sufficient volume of solution. An increase in the height of the container 100 would be required to obtain a desired internal volume, but would raise the center of gravity of the container 100, allowing the container 100 to flip over easily. In one embodiment, a maximum dimension of each of the first and second planar walls 110 and 112 is no more than ten times that of the distance between the first and second planar walls 110 and 112.

In one embodiment, the “dimensions” of each of the first and second planar walls are the height and width of 110 and 112. For example, if the distance between 110 and 112 is 6 cm, then the height and width of 110 and 112 should not exceed 60 cm. In another embodiment, the outside dimensions of the container are only limited in size and shape by the size and shape of the freezer used to store the containers.

Generally, in one embodiment of the invention, the planar interwall spacing is about midway between the limits of 5 cm and 11 cm (about 8 cm) to cover a range of conditions of materials to be contained. In another embodiment, planar interwall spacing is about 5, 5.5, 6, 6.5, 7, 7.5, 8, 8.5, 9, 9.5, 10, 10.5, or 11 cm to cover a range of conditions of materials to be contained. However, an interplanar wall distance from about 5 cm to about 11 cm should provide a desired freezing time for a wide range of materials and should keep any common solute redistribution within an acceptable limit. For different solutions with different thermodynamic properties, the rate of freezing will likely vary slightly, but it is believed by the inventor(s) that the distilled water, 0.5 M NaCl solution, and formulation buffers discussed above are representative of the thermodynamic properties of the types of solutions that may be stored within the container 100.

While the interplanar wall spacing may be from 5 to 11 cm and is generally to be about 8 cm in one embodiment, the height and width of each of the first planar wall 110 and the second planar wall 112 may be varied, depending upon the size of the freezer (not shown) into which the container 100 is intended to be placed to freeze the biopharmaceutical product 102 in the container 100, or by the desired interior volume of the container 100. For example, for the container 100 having a volume of 8 liters, either a length of about 300 millimeters and a height of about 500 millimeters or a length of about 400 millimeters and a height of about 400 millimeters provides the desired volume of the container 100.

A plurality of side walls circumscribe each of the first planar wall 110 and the second planar wall 112. As can be seen in FIG. 2, five side walls 120, 122, 124, 126, 128 connect the first planar wall 110 and the second planar wall 112, forming an interior volume within which the biopharmaceutical product 102 is contained. Four of the side walls 120, 122, 124, 126 are orthogonal to an adjacent side wall 120, 122, 124, 126, while the fifth side wall 128 extends at an oblique angle relative to at least one of its adjacent side walls 120, 126. The side walls 120, 122, 124, 126, 128 all fit within an area defined by an imaginary rectangle 130, with the side walls 122, 124 forming the entire corresponding side walls of the rectangle 130 and side walls 120, 126 forming a portion of the remaining side walls of the rectangle 130. In another embodiment, the side walls 120, 122, 124, 126, 128 all fit within an area defined by an imaginary square (not shown).

The first and second planar walls 110, 112 and the side walls 120, 122, 124, 126, 128 also serve to enhance heat transfer between the biopharmaceutical product 102 in the container 100 and the environment external to the container 100. In one embodiment, the first and second planar walls 110, 112 and the side walls 120, 122, 124, 126, 128 all have a thickness of between about 0.1 and 0.95 centimeters. In another embodiment, the first and second, planar walls 110, 112 and the side walls 120, 122, 124, 126, 128 all have a thickness of between about 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95 cm. The walls 110, 112, 120, 122, 124, 126, 128 are of such thickness to enhance heat transfer through the walls 110, 112, 120, 122, 124, 126, 128 during freezing of the biopharmaceutical product 102 within the container 100.

The side wall 128 includes a circular opening 132 formed therein. The opening 132 allows the biopharmaceutical product 102 to be poured into and out of the container 100. In one embodiment, the circular opening 132 is sealed with a plug (not shown) that provides adequate sealing of the opening 132 and containment of the biopharmaceutical product 102. In another embodiment, a nipple 134 having external threads 136 is formed around the opening 132 and extends outwardly from the side wall 128. The nipple 134 is sized such that the nipple 134 remains within the rectangle 130. The nipple 134 remains within the rectangle 130 to accommodate the entire container 100 when the container 100 is placed into a larger container, such as a freezer, with minimal wasted space between the container 100 and the freezer.

A removable cap 138 is releasably connectable to the nipple 134. In one embodiment, the cap 138 includes internal threads (not shown) that engage with the external threads 136 of the nipple 134 for a threaded fit. In another embodiment, the cap 138 includes a seal (not shown) that is located on the underside of the cap 138 to provide adequate sealing of the cap 138 with the nipple 134.

In one embodiment, the container 100 is constructed from high density polyethylene (HDPE), because it is known that HDPE is biocompatible with the types of biopharmaceutical product 102 that is intended to be stored within the container 100. However, those skilled in the art will recognize that other biocompatible materials may be used for the container 100 as well. For example, glass, metal, other biocompatible plastics, etc. One embodiment of the invention is that the material used to construct the container 100 should be rigid enough to maintain is structure or shape during its use and under freezing conditions. Furthermore, the material should be able to sustain the handling at a temperature ranged between +20° C. and −70° C.

In use, the cap 138 is removed from the nipple 134 and the biopharmaceutical product 102 is placed, transferred, or poured into the interior of the container 100. After the container 100 is filled with a desired amount of the biopharmaceutical product 102, the cap 138 is replaced over the nipple 134, sealing the container 100. The container 100 may now be transported to a freezer for freezing of the biopharmaceutical product 102. The container 100 is subjected to a heat transfer process by which heat contained in the container 100 and in the biopharmaceutical product 102 being stored within the container 100 is absorbed by the lower temperature of the exterior environment of the freezer surrounding the container 100. The relatively large surface areas of the first and second planar walls 110, 112 allow the biopharmaceutical product 102 to freeze while maintaining a generally homogeneous concentration of solute within the frozen solution. In another embodiment, the biopharmaceutical product 102 may be a mixture of at least one biopharmaceutical product, such as monoclonal antibodies, DNA, DNA vaccines, peptides, and other protein molecules.

Further, in another embodiment, the present invention is directed to a container that is used to remove heat from within the container over a reduced period of time to reduce the formation of a heterogeneous solution within the container, those skilled in the art will recognize that the container may also be used to add heat to material within the container over a reduced period of time and with reduced localized temperature differentiation, if so desired.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A container for storing a biopharmaceutical drug product comprising:
a first and second surface area planar walls extending opposite to one another; and
a plurality of smaller surface area side walls circumscribing each of said first and second surface area planar walls, wherein the plurality of side walls connect said first and second surface area planar walls, all of said surfaces collectively defining the interior of the container.

2. The container according to claim 1, wherein said first and second surface area planar walls are parallel surfaces.

3. The container according to claim 1, wherein one of the plurality of side walls extends at an oblique angle relative to an adjacent of the plurality of side walls.

4. The container according to claim 3, wherein the remaining of the plurality of side walls each define at least a portion of a side of a rectangle.

5. The container according to claim 4, further comprising an opening formed within one of the plurality of side walls.

6. The container according to claim 5, further comprising a nipple formed around the opening and extending outwardly from one of the plurality of smaller side walls.

7. The container according to claim 6, wherein the nipple extends within the rectangle.

8. The container according to claim 2, wherein the second planar surface is spaced from the first surface area planar wall by a distance of between about 5 to about 11 centimeters.

9. The container according to claim 8, wherein the second surface area planar wall is spaced from the first surface area planar wall by a distance of about 8 centimeters.

10. The container according to claim 1, wherein the first planar surface is spaced from the second planar surface by a distance, and wherein a maximum dimension of each of the first and second surface area planar walls is no more than ten times that of the distance.

11. The container according to claim 1, wherein said first and second surface area planar walls and the plurality of smaller side walls all have a thickness of between about 0.1 to about 0.95 centimeters.

12. A method of freezing a biopharmaceutical product comprising the steps of:
providing a container having:
a first and second surface area planar walls extending opposite to one another; and
a plurality of smaller surface area side walls circumscribing each of the first and second surface area planar walls, wherein the plurality of side walls connect said first and second surface area planar walls, all of said surfaces collectively defining the interior of the container;
inserting at least one biopharmaceutical product into the container;
subjecting the container to freezing conditions; and
freezing said at least one biopharmaceutical product within the container while maintaining a generally homogenous solution.

13. The method according to claim 12, wherein said first and second surface area planar walls are parallel surfaces.

14. The method according to claim 12, wherein said first and second surface area planar walls and the plurality of side walls all have a thickness of between about 0.1 to about 0.95 centimeters.
